(19) United States
(12) Patent Application Publication
(10) Pub. No.: US 2019/0141982 A1
(43) Pub. Date: May 16, 2019

(54) METHODS AND SYSTEMS FOR DIRECTING ANIMALS AWAY FROM AN AREA

(71) Applicant: Brian Wayne Carnell, Clayton, NC (US)

(72) Inventor: Brian Wayne Carnell, Clayton, NC (US)

(21) Appl. No.: 15/814,542

(22) Filed: Nov. 16, 2017

(51) Int. Cl. A01M 29/06; A01M 29/30; A01M 31/00; B64C 39/02

(52) U.S. Cl. CPC A01M 29/06; A01M 29/30; G05D 1/101; B64C 39/02; A01M 31/002

(57) ABSTRACT

Present invention is a system and method for chasing birds and other unwanted pest animals from a particular area. A robot is programmed to move toward the pest animal within a geofenced area until the pest animal leaves the geofenced area.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to directing pest animals away from an area. In particular, it relates to the use of robots (ground based and drones) to chase pest animals away.

### Description of Related Art

The need to repel pest animals from certain outdoor areas is well known. Pest animals, such as birds, not only leave a mess if they spend a lot of time in an area, their feces can destroy equipment, such as electronics, and leave behind diseases, such as the avian flu. The loiterers are a nuisance to those using the space and pose dangers to humans by flying into machinery or other objects, such as the turbines of airplanes and the like. In the case of crops, they can cause a reduction in the yield or even destroy the entire harvest. In the case of collision with machinery, the animals are usually killed and the equipment can be damaged resulting in significant repair costs or even the loss of life.

A number of different systems are available for dealing with pest animals but all have their drawbacks and limited effectiveness. In the example of birds, noise cannons and predator sounds work, but birds quickly become adapted to them when it is realized that there is no real danger. Stuffed owls and the like are utilized to represent the presence of a predator but don't fool the birds for long. Spike systems are deployed, but birds usually end up using them as convenient nest holders. Electric fences and strips are dangerous and often times leave the birds flapping on the ground for hours before they finally die. Scarecrows have been used in fields for as long as recorded history, but they have limited success due to the birds perceiving them as not being a threat.

In one more recent invention, drones are used to transmit a gradient field which can be utilized to direct the flight of the bird. It has its drawbacks in that some birds aren't affected and many become adapted that initially are affected.

### BRIEF SUMMARY OF THE INVENTION

The present invention relates to the discovery that by utilizing proximity sensors to identify when a pest animal has entered a predefined geofenced area, a robot can be utilized to physically scare one or more pest animals out of the geofenced area by continuously moving towards the pest animal until it leaves the area.

Accordingly, in one embodiment, there is a system for directing a pest animal out of a particular outdoor area comprising:
a) a system that electronically defines a geofence in the particular outdoor area;
b) a robot having a piloting system;
c) a detector for identifying a pest animal and determining when and where there is a pest animal in the geofenced outdoor area; and
d) software associated with the robot that, once a pest animal is determined to be in the geofenced area, continuously directs the robot's piloting system to find the pest animal and move toward the pest animal as long as the pest animal is detected within the geofenced outdoor area.

In another embodiment, there is a method for directing a pest animal out of a particular outdoor area comprising:
a) electronically defining a geofenced outdoor area;
b) electronically detecting when there is a pest animal in the geofenced outdoor area;
c) engaging a robot with a piloting system software associated with the robot that continuously directs the robot's piloting system to move toward the pest animal as long as the pest animal is detected within the geofenced outdoor area; and
d) disengaging the robot when there are no pest animals in the geofenced outdoor area.

### BRIEF DESCRIPTION OF THE DRAWINGS

FIG. 1a is a relationship figure of the present invention.

FIG. 1b is a bird detected entering the geofence zone.

FIG. 2 is a drone flying toward the bird, probe first, in order to chase the bird out of the geofence zone.

FIG. 3 is the bird having been driven from the geofence zone. The drone can go back to rest position.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “automated system” refers to a system which detects defined pest animals in a geofenced area, launches a robot, and the robot chases away the pest animal from the geofenced area without human intervention once the system is initiated. In other embodiments, individual steps may be either automatically or manually initiated.

As used herein, the term “pest animal” refers to any unwanted animal such as birds, pigeons, geese, coyotes, and the like which are large enough to be a nuisance on a given piece of property.

As used herein, the term “particular outdoor area” refers to an area wherein the user of the system wants to keep the area free from invasion of pest animals. This might be a back yard, an airport area, an industrial site, a golf course, and the like.

As used herein, the term “geofence” refers to the establishment of a digital map of the particular outdoor area that is electronically part of the system such that it can detect when a pest animal is in the particular geofenced outdoor area. It need not sense outside the area, and if the geofence cannot detect any movement, it needs no more input to operate. Geofencing is well known in the art.

As used herein, the term “robot with a piloting system” refers to a flying drone or ground unit with an operating system which allows the robot to visually inspect the geofenced area for pest animals in the geofenced area such that the software controlled interaction causes the robot to continuously maneuver toward any pest animal in the geofenced area as long as it remains in the geofenced area. Once the pest animal leaves the geofenced area, the robot returns to its original path to finish its patrol and, if no further pest animals are detected, the robot then returns to its docking station, or the like. While this can be automatic, in one embodiment a user has to initiate the system when notified of an intrusion into the geofenced area. A flying robot could be utilized for flying pest animals, like birds and bats, while a ground robot could be utilized for ground limited animals, like coyotes.

As used herein, the term “detector” is a device for identifying a pest animal and determining when and where there is a pest animal in the geofenced area. It can be located anywhere, including in or on the robot, a separate device, as shown in the figures, and the like.

As used herein, the term “software that directs the robot's piloting system” refers to software on a computer, on the web, on the robot, on multiple places, or any other place which coordinates the activity of measuring the location of the pest animal in the geofenced area with the robot such that the robot is constantly directed to move toward the pest animal until it leaves the geofenced area.

In use, the geofence system monitors inside the geofenced area for anything moving in that area of a certain size. In one embodiment, it is a recognition system that can tell the difference between a pest animal and something mechanical like another robot. If a pest animal is detected, the robot is activated (manually or automatically) and directed to continuously move toward the detected pest animal until the pest animal is no longer detected in the geofenced area. When equipped with an optional probe, the robot is directed to always have the probe facing the pest animal to poke the pest animal and further encourage it to leave.

### DRAWINGS

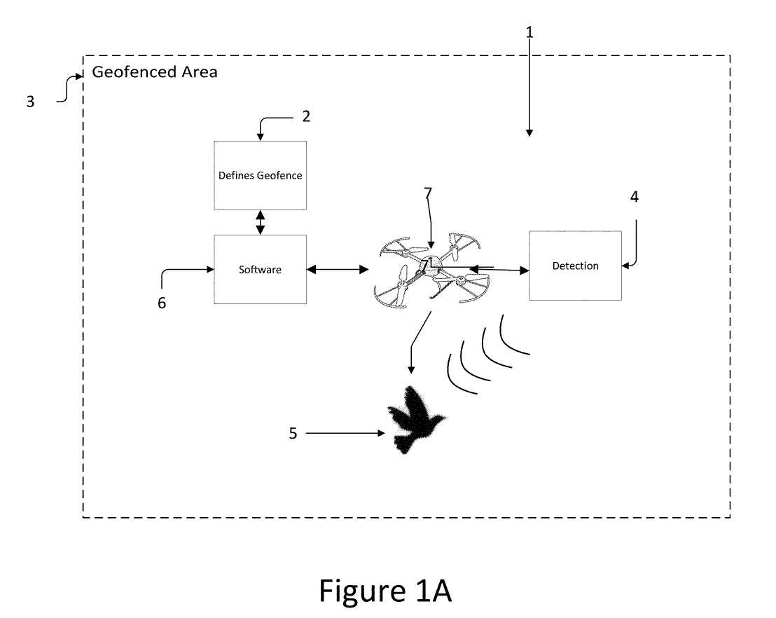

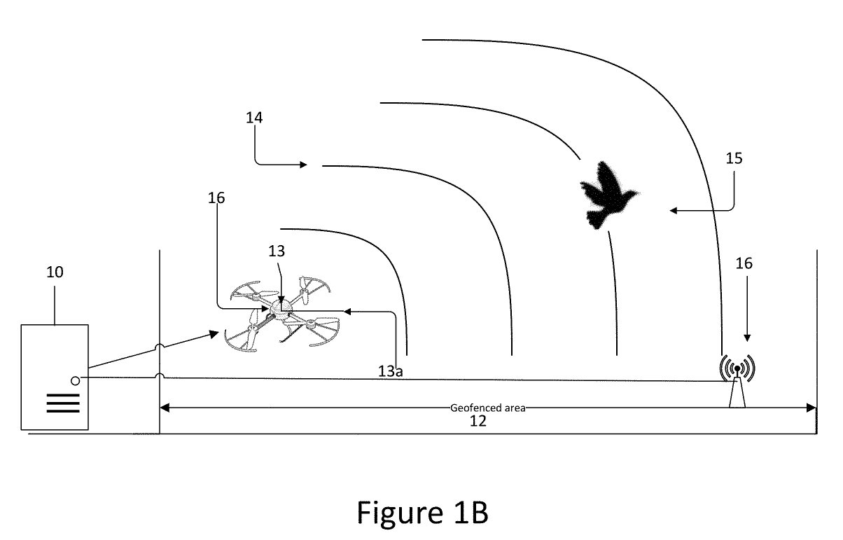

Now referring to the drawings, FIG. 1a is a relationship FIG. 1 of the present invention system. In this view, geofence software 2 determines where the geofenced area 3 is located. Once the geofenced area is determined, a detector 4 monitors for pest animals 5 inside the geofenced area. Once a pest animal is detected, software 6 guides a robot with a piloting system 7 to move toward pest animal 5. Once pest animal 5 is no longer detected by the detector or robot 4, the robot 7 stops the movement and returns to its predefined path to finish its patrol.

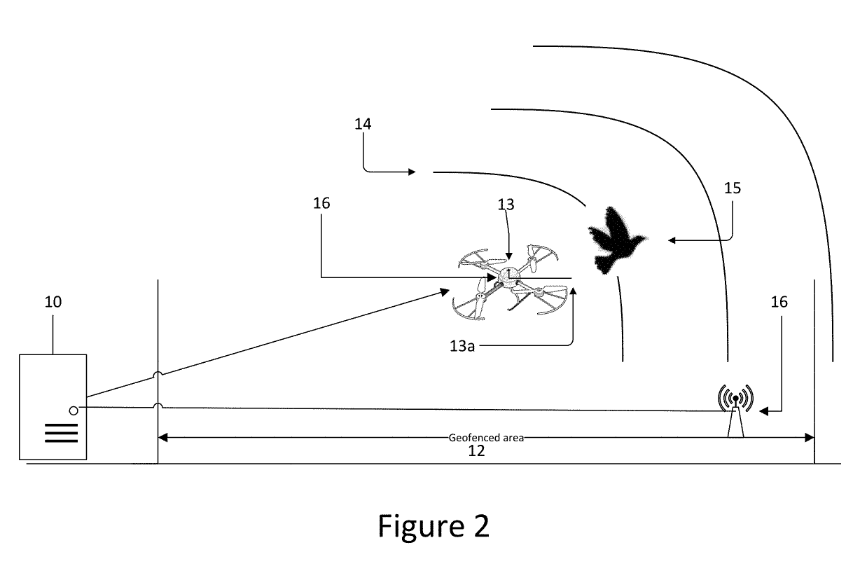

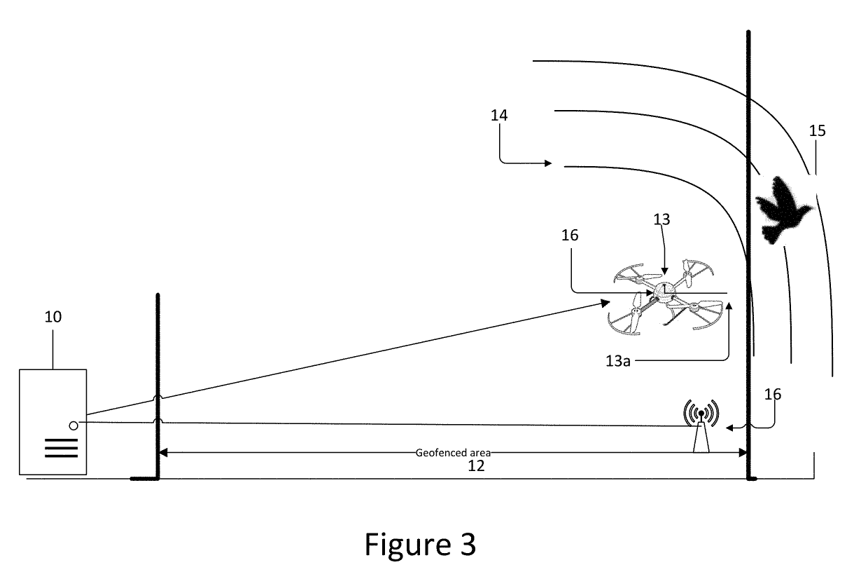

FIG. 1b is a graphic representation of the present invention. A device 10 is placed in the software defined geofenced area 12 (shown in two-dimensional view for clarity). A detector system 16 (which could also be inside drone 13, which could also be a land based device) operates to detect 14 pest animal 15 (in this embodiment a bird) inside the geofenced area 12. In FIG. 2, a drone 13 has taken off and is flying toward a bird 15. This drone 13 has an optional probe 13a which remains pointed toward bird 15 to aid in shooing the bird out of the geofenced area. In FIG. 3, the drone 13 has successfully driven the bird 15 out of the geofenced area 12 and can stop flying and return to its docking station or pick up on its patrol mission where it left off.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A system for directing a pest animal out of a particular outdoor area comprising:
a) a system that electronically defines a geofence in the particular outdoor area;
b) a robot having a piloting system;
c) a detector for identifying a pest animal and determining when and where there is a pest animal in the geofenced outdoor area; and
d) software associated with the robot that, once a pest animal is determined to be in the geofenced area, continuously directs the robot's piloting system to find the pest animal and move toward the pest animal as long as the pest animal is detected within the geofenced outdoor area.

2. A system according to claim 1 wherein there are multiple robots within a single geofenced outdoor area.

3. The system according to claim 1 wherein the robot is equipped with a camera for determining where to move toward the pest animal.

4. The system according to claim 1 wherein the robot piloting system has a system for identifying a pest animal.

5. The system according to claim 2 wherein the multiple robots cooperate in forcing the pest animal from the geofenced area.

6. The system according to claim 1 wherein the robot is equipped with a probe to touch the pest animal.

7. The system according to claim 1 wherein the detector is a motion activated visual detector.

8. The system according to claim 1 wherein the system is completely autonomous once the system is engaged.

9. The system according to claim 1 wherein at least 1 of a, b, c, and d is initiated manually by a user.

10. The system according to claim 1 wherein the robot is manually engaged once the pest animal is determined to be in the geofenced area.

11. A method for directing a pest animal out of a particular outdoor area comprising:
a) electronically defining a geofenced outdoor area;
b) electronically detecting when there is a pest animal in the geofenced outdoor area;
c) engaging a robot with a piloting system software associated with the robot that continuously directs the robot's piloting system to move toward the pest animal as long as the pest animal is detected within the geofenced outdoor area; and
d) disengaging the robot when there are no pest animals in the geofenced outdoor area.

12. The method according to claim 11 wherein the robot is equipped with a probe and the robot orients itself while moving toward the pest animal such that the probe will be oriented toward the pest animal.

13. The method according to claim 11 wherein detection is accomplished by using a motion detector that operates within the geofenced outdoor area.
